(19) United States
(12) Patent Application Publication
(10) Pub. No.: US 2008/0219392 A1
(43) Pub. Date: Sep. 11, 2008

(54) Data-Dependent Noise Predictor in Data-Aided Timing Recovery

(75) Inventors: Jamal Riani, Eindhoven (NL); Steven J-M.L. Van Beneden, Eindhoven (NL); Johannes Wilhelmus Maria Bergmans, Eindhoven (NL); Albert Hendrik Jan Immink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,013

(22) PCT Filed: Jul. 6, 2006
(86) PCT No.: PCT/IB2006/052277

§ 371 Date: Jan. 8, 2008

(30) Foreign Application Priority Data
Jul. 13, 2005 (EP) 05106383.2

(51) Int. Cl. H04L 7/00; H04L 25/00

(52) U.S. Cl. 375/371

(57) ABSTRACT

A communication system includes a communication channel (110) for time-synchronous transfer of data symbols a₁, . . . , a_{N} to a receiver (130). A sampling unit (132) is used for time-sequential sampling the channel under control of a sampling clock signal that is synchronous with transmittal of the data symbols. Each sample includes a representation of a data symbol and noise. A data-aided timing error detector (133) receives a representation of the samples. The detector includes a data-dependent noise predictor (310) for generating a predicted noise sequence ñ₁, . . . , ñ_{N} where each predicted noise value nₖ for the k-th sample of the sequence depends on a cluster of a plurality of sampled data symbols and a noise whitening unit (320) for whitening of noise in the sample sequence by removing the predicted noise value ñₖ. The detector is arranged to provide a signal for correcting the sampling clock signal in dependence on the whitened sample sequence.

The invention relates to a method of recovering the timing in a synchronous communication system.

The invention also relates to a system for performing the method and to a receiver for use in the system.

Timing recovery is one of the critical functions for reliable data detection in digital synchronous communication systems. Such systems are frequently used in storage systems like optical storage (e.g. DVD, Blu-Ray Disc, High-density DVD, etc.) and magnetic storage (e.g. hard disk). Synchronous communication networks also exist, for example, IEEE 1394 and USB.

A key problem in timing recovery is the determination of time instants at which the received signal should be sampled for reliable data recovery. This problem has been a subject of investigation for many decades. Among the existing solutions data-aided (DA) timing recovery schemes are known to be more powerful. DA schemes use the transmitted data sequence as side information to facilitate timing recovery. This information is available to the receiver either in the form of a known preamble pattern preceding the user data, or as decisions taken from the bit detector. Existing timing recovery schemes assume that the noise at their input is stationary and that noise statistics are independent of the transmitted data.

Timing recovery becomes more critical as the baud rate increases.

It is an object of the invention to provide a system, receiver and method of the kind set forth that provides improved timing recovery.

To meet an object of the invention, a digital synchronous communication system includes a digital synchronous communication channel for time-synchronous transfer of a sequence of data symbols a₁, . . . , a_{N} and a receiver; the receiver including:

a sampling unit for time-sequential sampling an output of the channel under control of a sampling clock signal that is synchronous with transmittal of the data symbols on the channel of data symbols transmitted; each sample of the sequence of samples including a representation of a data symbol and noise; and

a data-aided timing error detector for providing a correction signal for correcting the sampling clock signal; the timing error detector being coupled to the sampling unit for receiving a representation of the time sequence of samples and including:
a data-dependent noise predictor for generating a predicted noise sequence \hat{n}₁, . . . , \hat{n}_{N} where each predicted noise value \hat{n}ₖ for the k-th sample of the sequence depends on a cluster of a plurality of sampled data symbols; and
a noise whitening unit for whitening of noise in the sample sequence by removing the predicted noise value \hat{n}ₖ;

the timing error detector being arranged to provide the correction signal in dependence on the whitened sample sequence.

According to the invention, the timing error detector predicts the noise dependent on a plurality of sampled data symbols. It improves the performance of existing detectors by dealing with the fact that in many communication systems noise is not stationary and that noise statistics are dependent of the transmitted data. This data-dependent nature of the noise significantly deteriorates the performance of conventional timing recovery schemes. It increases timing jitter, i.e. the difference between the ideal and the estimated sampling instants, at a given loop bandwidth. Large timing jitter leads to frequent loss of lock and thus to an increased bit-error rate. Therefore, according to the invention the noise is whitened by removing a data-dependent estimate of the noise. Thus the signal on which the timing recovery operates is cleaner and allows a better recovery. The noise whitening may take place on the sample sequence that still includes a representation of the data symbols (i.e. the full samples) or just on the noise part of the sampled sequence.

According to the measure of dependent claim 2, the noise-predictor is arranged to use a data-dependent finite-order Markov process for modeling the noise. Using this model gives a good estimate of the noise, allowing obtaining a cleaner signal.

According to the measure of dependent claim 3, the timing error detector is arranged to perform a maximum likelihood timing error detection. This is an effective way of executing the timing error recovery.

According to the measure of dependent claim 4, wherein the timing error detector is arranged to adaptively estimate parameters of the noise model on a sample-by-sample basis. In practice, the statistics of the noise are not known and need to be estimated from the received signal. An adaptation algorithm is used that estimates and tracks noise model parameters on a sample-by-sample enabling the system to cope better with non-stationary noise and quickly adapt to changes.

According to the measure of dependent claim 5, the timing error detector further includes means for determining a reliability measure of a cluster of samples and further being arranged to provide the correction signal by weighing a gain in extraction of timing information for a cluster of samples by the determined reliability measure by assigning a higher gain weight to more reliable clusters. In this way, sample clusters that are more reliable (less noisy) play a bigger role in the timing recovery than less reliable clusters. This improves the accuracy of the recovery.

According to the measure of dependent claim 6, the reliability measure is a noise variance of the whitened noise sequence. This is an effective measure for distinguishing between more reliable and less reliable clusters.

According to the measure of dependent claim 7, the gain weight is inversely proportional to the square of the noise variance. This achieves an optimal effect.

According to the measure of dependent claim 8, further including a storage device acting as a source of the communication channel. Any suitable storage device may be used, such as optical storage or magnetic storage.

An object of the invention is also met by a receiver of the kind set forth for use in the system.

An object of the invention is also met by a method of providing a correction signal for correcting a sampling clock signal for time-sequential sampling an output of a digital synchronous communication channel for time-synchronous transfer of a sequence of data symbols a₁, . . . , a_{N} under control of a sampling clock signal that is synchronous with transmittal of the data symbols on the channel; each sample of the sequence of samples including a representation of a data symbol and noise; the method including:

receiving a representation of the time sequence of samples;

generating a predicted noise sequence \hat{n}₁, . . . , \hat{n}_{N} where each predicted noise value \hat{n}ₖ for the k-th sample of the sequence depends on a cluster of a plurality of sampled data symbols;

whitening noise in the sample sequence by removing the predicted noise value \hat{n}ₖ; and

providing the correction signal in dependence on the whitened sample sequence.

These and other aspects of the invention are apparent from and will be elucidated with reference to the embodiments described hereinafter.

In the drawings:

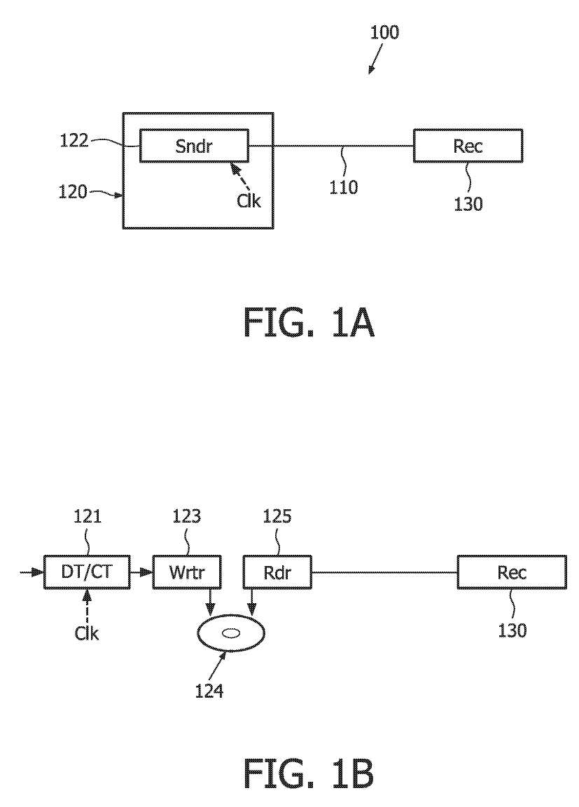

FIGS. 1A and B show block diagrams of a exemplary system in which the invention may be employed;

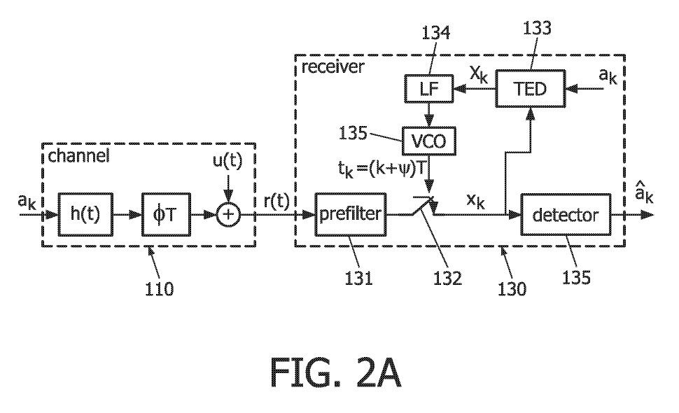

FIGS. 2A and 2B show a more detailed block diagram of a receiver according to the invention;

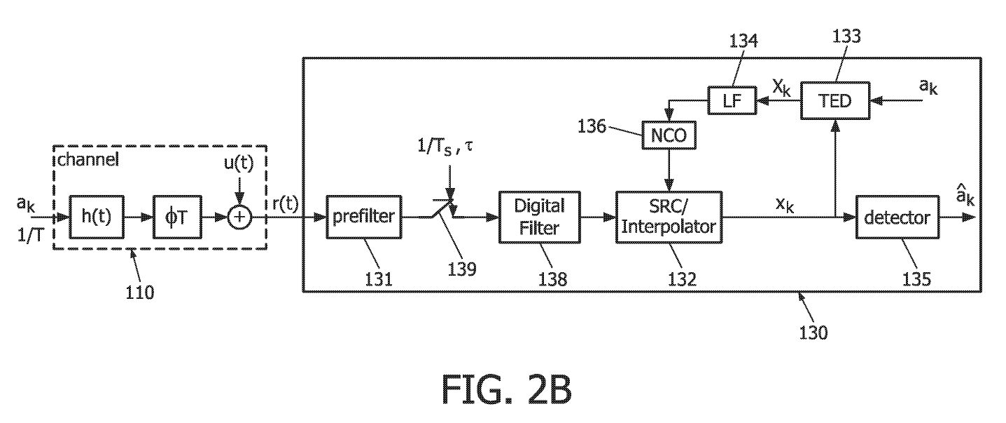

FIG. 3 shows the three main steps according to the invention;

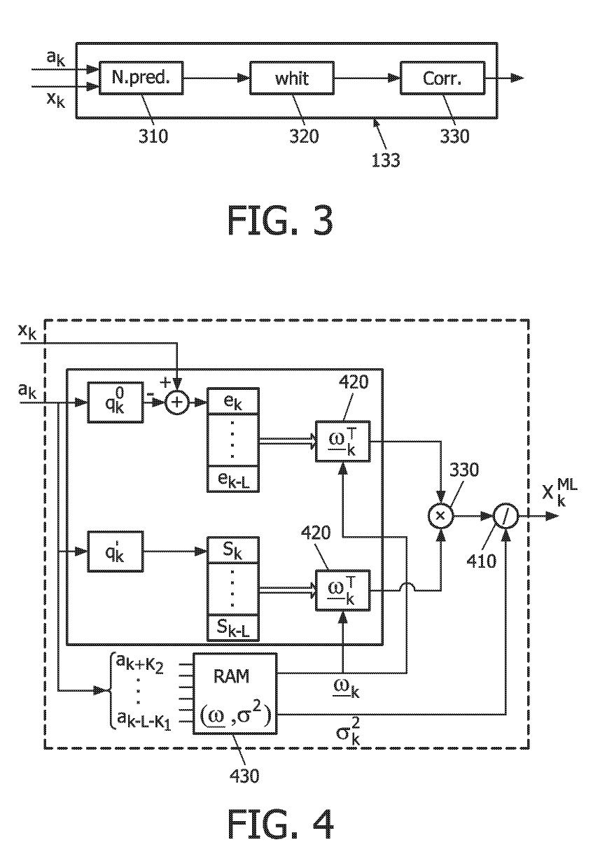

FIG. 4 shows a preferred embodiment; and

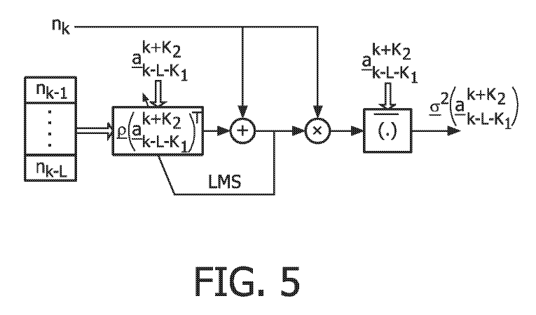

FIG. 5 shows a preferred embodiment for adapting the parameters.

FIG. 1 shows a block diagram of a digital synchronous communication system 100 according to the invention. The system 100 includes a digital synchronous communication channel 110 for time-synchronous transfer of a sequence of data symbols a₁, . . . , a_{N} from a source/sender 120 to a sink/receiver 130. The system 100 optionally includes the source/sender 120. The system is synchronous in the sense that both the source/sender and the sink/receiver are synchronized to one and the same clock that can be derived from the communication channel. For example, one of the two parties may include or be attached to the main clock. In a simple arrangement, the source/sender includes the main clock 122 and the receiver attempts to recover the clock as good as possible form the communication channel. The source/sender transmits a sequence of data symbols a₁, . . . , a_{N} via the channel 110. Such a series of data symbols may be referred to as block or frame.

FIG. 1A shows an exemplary block diagram where a synchronous external communication system is used. In this case, the source/sender 120 is external to the system 100. The communication channel may be any suitable type of external synchronous communication channel, e.g. IEEE 1394, USB, Bluetooth, IEEE 802.11, ADSL, GPRS, etc. The channel may include a wired or wireless communication medium. The sender and receiver include suitable interfaces for performing the communication. Typically, the block is encoded/modulated for transmission in such a way that the receiving party can derive a clock signal from it (or synchronize/lock an own clock to the received signal). In itself synchronous networks and this form of synchronous transmission are well-known. The channel may be point-point but may also allow more than two parties to communicate. As described above, the sender may provide the main timing, where the receiver locks to the timing provided by the sender through the channel. However, it is also known that the receiver can provide the main timing for the channel (the sender locking to the channel) or even that a third party provides the main timing (e.g. generate the main frame structure where a source only inserts some data symbols in payload part of a frame into a stream on the channel). In a synchronous communication bus such a third party is usually referred to as the bus master and both the sender and receiver lock to the channel. It will be appreciated that in such an arrangement from the point of timing recovery the sender of the actual data symbols is also a ‘receiver’ according to the invention, since it receives frame data symbols from the actual communication master and recovers/synchronizes to a clock signal of the communication channel.

FIG. 1B shows an exemplary block diagram where a synchronous ‘internal’ communication channel is used. This is typically the case where the source data is stored in a storage medium 124, like optical storage (e.g. DVD, Blu-Ray, High density DVD) or magnetic storage, like a hard disk. Digital source data (the data symbols a₁, . . . , a_{N}) are converted from the digital time domain to the continuous (analogue) time domain in block 121 under control of the main clock 122. A write unit 123 writes the data to the storage medium 124. At later moment in time, a read unit 125 reads the data from the storage medium 124. The receiver 130 samples the data under control of a clock signal locked to received stream. In this scenario, the combination of blocks 121, 123, 124 and 125 can be seen as the communication channel 110.

In the remainder, the source of a data signal will also be referred to as sender and the sink/receiver will be referred to as receiver.

FIGS. 2A and 2B show block diagrams of a preferred receiver 130. Where in the figures the same reference numerals are used, substantially the same functions are involved. The receiver 130 includes a sampling unit 132 for time-sequential sampling of data symbols transmitted via the channel 110 under control of a sampling clock signal. Sampling units are well-known and will not be described any further. The sampling clock signal is synchronous with transmittal of the data symbols on the channel. The receiver 130 further includes a data-aided timing error detector (TED) 133 for providing a correction signal for correcting the sampling clock signal. The timing error detector 133 is coupled to the sampling unit 132 for receiving a representation of the time sequence of samples. FIG. 2 shows two exemplary arrangements which in itself are known. FIG. 2A shows a traditional analogue locking (synchronizing) of the sampling clock signal, whereas FIG. 2B shows a conventional arrangement for digitally locking the sampling clock signal to the communication channel. The receiver may include a prefilter 131 for prefiltering the signal r(t) received for the communication channel. The prefilter 131 serves to suppress noise and may also condition intersymbol interference (ISI). The received signal (that preferably is prefiltered) is first sampled by the sampling unit 132 and then passed to a detector 135 that produces estimates âₖ of the received data symbols. The estimates may take any suitable form such as hard or soft bit decisions. The receiver includes a timing recovery subsystem that aims to provide a sampling clock that is close to the original clock in frequency and phase. As such the timing recovery subsystem operates as a phase-locked loop. The timing recovery subsystem includes at least the timing error detector 133 according to the invention. It may further include a loop filter (LF) 134 to improve the performance of the timing recovery, in particular to improve the tracking of the sampling frequency. In itself such a loop filter is known. In the analogue sampling of FIG. 2A, the timing recovery subsystem may also include a voltage controlled oscillator (VCO) 135. In the digital version of FIG. 2B, instead of a VCO a numerically controlled oscillator (NCO) 136 is used. The output of the NCO is then used for accurate sampling of the received digital signal. The digital signal has already been sampled by an asynchronous sampling unit 139 that is free running (e.g. operating under control of a clock signal a nominal sampling frequency derived from a crystal). The accurate synchronous sampling according to the invention may then be performed digitally by ‘resampling’ the already sampled signal, shown in block 132. This may take any suitable form, for example through interpolation or sample rate conversion (SRC). The initially sampled signal may optionally be digitally filter by a digital filter 138 before being re-sampled.

In the remainder of the description it is assumed that a zero-mean data sequence aₖ of length N, i.e. a₁, . . . , a_{N} of data rate 1/T is applied to the communication channel 110. It is assumed that the channel has a symbol response h(t) (the fourier transfer of h(t) is usually referred to as the transfer function). Noise that is added during transfer through the channel is referred to as u(t). The channel also adds an a priori unknown and possibly time varying delay φ (in bit intervals T). For clarity of the description, it is assumed that excess bandwidth at the prefilter output is negligible. The description further focuses on baud-rate sampling. The technique can be applied to any number of bits sampled at a time. The invention can also be extended to a system that uses oversampling (i.e. the sampling unit operates at a higher frequency then the clock directly derived from the channel). In the description, the sampling instants are expressed as tₖ=(k+ψ)T where ψ is a sampling phase (normalized in units 7). Based on the sampled sequence xₖ, the receiver produces bit decisions âₖ as well as a clock signal that indicates the sampling instants tₖ. In order for the detector to operate properly, the timing recovery subsystem ensures that the sampling phase ψ closely approaches φ.

FIG. 3 shows a block diagram of the timing error detector 133 according to the invention. The timing error detector 133 includes a data-dependent noise predictor 310 for generating a predicted noise sequence \hat{n}₁, . . . , \hat{n}_{N} where each predicted noise value \hat{n}ₖ for the k-th sample of the sequence depends on a cluster of a plurality of samples. The timing error detector 133 further includes a noise whitening unit 320 for whitening of noise in the sample sequence by removing the predicted noise value \hat{n}ₖ. The timing error detector 133 then feeds the whitened signal into a unit 330 that provide the correction signal in dependence on the whitened sample sequence. This unit 330 may be a conventional unit for generating a correction signal, but now according to the invention it is fed with a signal that has been whitened in a data dependent manner whereas the unit 330 conventionally operates on an uncorrected signal. In the remainder the TED is described as providing an estimate Ωₖ of the sampling-phase error Δ=φ−ψ. It will be appreciated that other suitable correction signals may also be provided. In a preferred embodiment, the functions of the units 310 and 320 may be integrated as will be shown in more detail below.

The description focuses on a data-aided (DA) TED where aₖ is assumed to be available to the receiver. For example, the data sequence aₖ is given in the form of a known preamble. If the bit-error rates are small the data sequence aₖ may also be the decisions taken from the detector (actually then the estimated data sequence is taken). Also error correction techniques may be used to improve the accuracy of the estimate. Such techniques are well-known and outside the scope of this invention.

According to the invention, the noise predictor 310 is data dependent, i.e. it depends on the received data sequence aₖ (or as described above, the estimated data sequence). It generates a predicted noise sequence \hat{n}₁, . . . , \hat{n}_{N} where each predicted noise value \hat{n}ₖ for the k-th sample of the sequence depends on a cluster of a plurality of samples. As will be described in more detail below, the cluster typically includes at least sample aₖ and at least one immediately preceding or immediately following sample (i.e. aₖ₋₁ and/or aₖ₊₁). The noise whitening unit 320 whitenes the noise in the sample sequence by removing (e.g. subtracting) the predicted noise value \hat{n}ₖ from the sequence. The timing error detector according to the invention is thus arranged to provide the correction signal in dependence on the whitened sample sequence.

To simplify the description it is assumed that the loop filter 134 has a sufficiently high bandwidth to enable the variations of φ to be tracked. Under this assumption φ can be considered to be fixed. Second, the sampling-phase errors Δ are restricted to a fraction of a symbol interval T (this reflects the situation when the PLL is in lock; PLL acquisition properties are not part of the invention and are in itself well-known). In this case, the equivalent discrete impulse response qₖ of the system up until the detector input can be linearized as qₖ^{Δ}≈qₖ⁰+Δqₖ′, where qₖ′ is the derivative of qₖ^{Δ} with respect to Δ at Δ=0. Both responses qₖ⁰ and qₖ′ are assumed to be known to the receiver. The detector input sequence can be written as

xₖ≈˜(q⁰*a)ₖ+Δ(q′*a)ₖ+nₖ, (1)

where ‘*’ denotes linear convolution and nₖ is the equivalent noise sequence at the detector input, i.e. nₖ=xₖ−(q^{Δ}*a)ₖ. Unless specified otherwise, it is assumed that qₖ⁰ corresponds to the ideal ISI structure assumed by the detector. Any misequalization ISI (linear or nonlinear) at ideal sampling phase, i.e. due to a mismatch between qₖ⁰ and the ideal detector response, is embedded in the noise nₖ. The noise nₖ includes also channel noise that may be linearly or nonlinearly data-dependent.

According to the invention, a data-aided timing error detector is used that includes a data-dependent noise predictor where each predicted noise value \hat{n}ₖ for the k-th sample of the sequence depends on a cluster of a plurality of sampled data symbols. Preferably, a finite data-dependent span is used where nₖ depends only on its first K-neighbor symbols. According to the invention, this may include K₁ preceding data symbols (K₁≧1) and/or K₂ successive data symbols (K₂≧1). In the remainder it is assumed that the noise nₖ depends on K=K₁+K₂+1 of successive data symbols (referred to as a symbol cluster), with K₁≧0 and K₂≧0, indicated as a_{k-K}_{₁}^{k+K}^{₂}.

In a preferred embodiment, the noise model is used that was described in A. Kavcic and A. Patapoutian, “A Signal-Dependent Autoregressive Channel Model,” IEEE Trans. Magn., vol. 35, no. 5, pp. 2316-2318, September 1999. Other suitable data dependent noise models may also be used. In this preferred model, the noise-predictor is arranged to use a data-dependent finite-order Markov process for modeling the noise. Thus, a finite correlation length is used: the noise nₖ is assumed to be independent of past noise samples before some length L≧0 (finite Markov memory length). This independence implies that

p(nₖ|nₖ₋₁, . . . , n₁,a₁^{N})=p(nₖ|nₖ₋₁, . . . n_{k-L},a₁^{N}) (2)

where p(·) denotes the probability density function (pdf) of nₖ conditioned on the past noise samples and on the data a₁^{N} where aᵢ^{j}=[aᵢ, aᵢ₊₁, . . . , aⱼ] for j≧i. The conditioning on a₁^{N} is meant to take into account the data-dependent correlation of the noise nₖ.

Combining this preferred dependency on noise samples with the dependency on data symbols means that the conditioned noise pdf given in Eq. (2) becomes:

p(nₖ|nₖ₋₁, . . . , n_{k-L},a₁^{N})=p(nₖ|nₖ₋₁, . . . , n_{k-L},a_{k-L-K}_{₁}^{k+K}^{₂}) (3)

For the remainder of the description joint Gaussian pdf's are used. The joint pdf p(nₖ|nₖ₋₁, . . . , n_{k-L}, a_{k-L-K}_{₁}^{k+K}^{₂}), conditioned on the data sequence, is Gaussian with a covariance matrix C(a_{k-L-K}_{₁}^{k+K}^{₂}) of size (L+1)×(L+1), i.e.

$$p ( {n}_{k} \vert {n}_{k - 1} , … , {n}_{k - L} , {\underline{a}}_{k - L - {K}_{1}}^{k + {K}_{2}} ) = \frac{exp [ - {\underline{N}}_{k}^{T} {C}_{k}^{- 1} {\underline{N}}_{k} ]}{\sqrt{{( 2 π )}^{L + 1} det {C}_{k}}} , \qquad ( 4 )$$

where [·]T denotes the transpose operation and the (L+1)×1 vector Nₖ=[nₖ, . . . , n_{k-L}]^{T}.

Preferably, the timing error detector is arranged to perform a maximum likelihood timing error detection. Data-aided (DA) Maximum Likelihood (ML) timing recovery is optimum when no prior statistical knowledge about the phase-error Δ is available. Before describing the DA ML TED for sample-by-sample timing recovery, first the one-shot ML estimator of the phase-error Δ is derived based on the observation of the overall detector input sequence x₁, . . . , x_{N}. To this aim, it is assumed that noise statistics are known and fixed during the transmission of the N symbols a₁^{N}. The DA ML estimate of the phase-error Δ is obtained by maximizing the likelihood function, i.e.

$${Δ}^{ML} = arg {max}_{δ} p ( {x}_{1} , … , {x}_{N} \vert {\underline{a}}_{1}^{n} , Δ = δ ) , \qquad ( 5 )$$

over all possible phase-errors δ, where the likelihood function p(x₁, . . . , x_{N}|a₁ⁿ, Δ=δ), is the joint probability density function of the received samples x₁, . . . , x_{N} conditioned on the transmitted symbols a₁^{N} and on the phase-error Δ=δ. In order to derive a practical criterion from (5) some conventional steps are used. First, the Bayes rule is applied which gives:

$$p ( {x}_{1} , … , {x}_{N} \vert {\underline{a}}_{1}^{n} , δ ) = {\prod }_{k = 1}^{N} p ( {x}_{k} \vert {x}_{k - 1} , … , {x}_{1} , {\underline{a}}_{1}^{n} , δ ) . \qquad ( 6 )$$

Upon invoking (1), (2) and (3) and applying Bayes rule once again, (6) can then be factorized into

$$\begin{matrix}p ( {x}_{1} , … , {x}_{N} \vert {\underline{a}}_{1}^{n} , δ ) = {\prod }_{k = 1}^{N} \frac{p ( {x}_{k} , {x}_{k - 1} , … , {x}_{k - L} \vert {\underline{a}}_{k - L - {K}_{1}}^{k + {K}_{2}} , δ )}{p ( {x}_{k - 1} , … , {x}_{k - L} \vert {\underline{a}}_{k - L - {K}_{1}}^{k + {K}_{2}} , δ )} . \\ The right \text{-} hand factors in ( 7 ) can be rewritten using ( 4 ) as \text{:} & ( 7 ) \\ \frac{p ( {x}_{k} , {x}_{k - 1} , … , {x}_{k - L} \vert {\underline{a}}_{k - L - {K}_{1}}^{k + {K}_{2}} , δ )}{p ( {x}_{k - 1} , … , {x}_{k - L} \vert {\underline{a}}_{k - L - {K}_{1}}^{k + {K}_{2}} , δ )} ∝ \frac{exp [ - {( {\underline{E}}_{k} - δ {\underline{S}}_{k} )}^{T} {C}_{k}^{- 1} ( {\underline{E}}_{k} - δ {\underline{S}}_{k} ) ]}{exp [ - {( {\underline{e}}_{k} - δ {\underline{s}}_{k} )}^{T} {C}_{k}^{- 1} ( {\underline{E}}_{k} - δ {\underline{s}}_{k} ) ]} . & ( 8 )\end{matrix}$$

where the L×L matrix cₖ is the lower principal submatrix of

$${C}_{k} = [ \begin{matrix}{α}_{k} & {\underline{v}}_{k}^{T} \\ {\underline{v}}_{k} & {c}_{k}\end{matrix} ]$$

and where the column vectors Eₖ, eₖ, Sₖ and sₖ are given, as function of the error signal eₖ=xₖ−(q⁰*a)ₖ and the so called signature signal sₖ=(q′*a)ₖ, by Eₖ=[eₖ, . . . , e_{k-L}]^{T}, eₖ=[eₖ₋₁, . . . , e_{k-L}]^{T}, Sₖ=[sₖ, . . . , s_{k-L}]^{T}, sₖ=[sₖ, . . . , s_{k-L}]^{T}.

The proportionality factor in (8) equals

$$\sqrt{\frac{{( 2 π )}^{L} det {c}_{k}}{{( 2 π )}^{L + 1} det {C}_{k}}}$$

which is independent of δ. It follows, by taking the logarithm of (7), that ML phase-error estimation is obtained by minimizing the following cost function:

$$Λ ( δ ) = {\sum }_{k = 1}^{N} {( {\underline{E}}_{k} - δ {\underline{S}}_{k} )}^{T} {C}_{k}^{- k} ( {\underline{E}}_{k} - δ {\underline{S}}_{k} ) - {( {\underline{e}}_{k} - δ {\underline{s}}_{k} )}^{T} {c}_{k}^{- 1} ( {\underline{e}}_{k} - δ {\underline{s}}_{k} ) . \qquad ( 9 )$$

This expression is still quite complex in that it involves inversions of the matrices Cₖ and cₖ for all possible symbol clusters a_{k-L-K}_{₁}^{k+K}^{₂}. A simplified expression can be derived via the matrix inversion lemma and reads:

$$Λ ( δ ) = {\sum }_{k = 1}^{N} \frac{1}{{σ}_{k}^{2}} {( {\underline{w}}_{k}^{T} ( {\underline{E}}_{k} - δ {\underline{S}}_{k} ) )}^{2} , \qquad ( 10 )$$

where

$${\underline{w}}_{k} = [ \begin{matrix}1 \\ - {c}_{k}^{- 1} {\underline{v}}_{k}\end{matrix} ]$$

of size (L+1)×1 and σₖ²=αₖ−vₖ^{T}cₖ⁻¹vₖ. The computational complexity is brought down to O(N(L+1)) in (10) instead of O(N(L+1)²) in (9). The vectors cₖ⁻¹vₖ can be interpreted as data-dependent noise predictors and the values σₖ² as noise prediction variances. In fact, for a given symbol cluster a_{k-L-K}_{₁}^{k+K}^{₂}, wₖ=w(a_{k-L-K}_{₁}^{k+K}^{₂}) acts to whiten the noise nₖ by subtracting from nₖ the predicted component from the past noise samples. The variance of the whitened noise, i.e. wₖ^{T}Nₖ, equals σₖ².

The ML one-shot phase-error estimate Δ^{ML} can be easily derived from (10) and is given by:

$${Δ}^{ML} = \frac{1}{{\sum }_{k = 1}^{N} \frac{1}{{σ}_{k}^{2}} {( {\underline{w}}_{k}^{T} {\underline{S}}_{k} )}^{2}} {\sum }_{k = 1}^{N} \frac{1}{{σ}_{k}^{2}} ( {\underline{w}}_{k}^{T} {\underline{E}}_{k} ) ( {\underline{w}}_{k}^{T} {\underline{S}}_{k} ) . \qquad ( 11 )$$

The ML phase-error estimate (11) can be seen as a normalized average of an instantaneous timing error function given by

$$\frac{1}{{σ}_{k}^{2}} ( {\underline{w}}_{k}^{T} {\underline{E}}_{k} ) ( {\underline{w}}_{k}^{T} {\underline{S}}_{k} ) .$$

Because, in a PLL based timing recovery scheme, the averaging operation is ensured by the loop filter, the ML timing error detector (ML-TED) can be simply written as

$${χ}_{k}^{ML} = \frac{1}{{σ}_{k}^{2}} ( {\underline{w}}_{k}^{T} {\underline{E}}_{k} ) ( {\underline{w}}_{k}^{T} {\underline{S}}_{k} ) , \qquad ( 12 )$$

where the vector wₖ=w(a_{k-L-K}_{₁}^{k+K}^{₂}) and the scalar σₖ²=σ²(a_{k-L-K}_{₁}^{k+K}^{₂}) correspond to the cluster a_{k-L-K}_{₁}^{k+K}^{₂}.

Equation (12) presents two interesting properties. First, the division with σₖ² provides a weighing for every cluster of symbols a_{k-L-K}_{₁}^{k+K}^{₂}. In this preferred embodiment, the weight of a given cluster is inversely proportional to σₖ². In the block diagram of the ML-TED as shown in FIG. 4, the weighing (actually division with (σₖ²) is shown in block 410. More reliable symbol clusters that have smaller ‘unpredictable’ noise variance will be attributed higher gains in the extraction of timing information than noisy clusters. It will be appreciated that other weights may also be used. Second, the ‘predictable’ component of nₖ from nₖ₋₁, . . . , n_{k-L} is removed via the scalar product with wₖ, allowing thus less noise power to be sensed by the timing recovery subsystem. The blocks 420 in FIG. 4 perform both the noise prediction 310 as well as the whitening 320 of FIG. 3. In block 430 estimated parameters, in particular w and σ² are stored, for example in RAM.

### Adaptive Data-Dependent Noise Characterization

In the previous section, it is assumed that w(a_{k-L-K}_{₁}^{k+K}^{₂}) and σ²(a_{k-L-K}_{₁}^{k+K}^{₂}) are known for all symbol clusters. However, the statistics of the noise are not known in practice and need to be estimated from the received signal. Moreover, tracking these statistics adaptively is preferable in many applications because the noise may be nonstationary. An estimation algorithm of the noise model parameters was presented in A. Kavcic and A. Patapoutian, “A Signal-Dependent Autoregressive Channel Model,” IEEE Trans. Magn., vol. 35, no. 5, pp. 2316-2318, September 1999. This is based on first estimating the covariance matrices C(a) and then deriving the vectors w(a) and the variances σ²(a) via solving a linear equation that involves inverting the matrices C(a). This means that at every adaptation of one w(a) a covariance matrix needs to be inverted which can be complex especially for high values of L. In a preferred embodiment, the following approach is used that does not involve inverting the covariance matrices. In fact, as described above, the scalar product with

$$\underline{w} ( {\underline{a}}_{k - L - {K}_{1}}^{k + {K}_{2}} ) = [ \begin{matrix}1 \\ - \underline{ρ} ( {\underline{a}}_{k - L - {K}_{1}}^{k + {K}_{2}} )\end{matrix} ]$$

is meant to whiten the noise samples nₖ, . . . , n_{k-L}, for the symbol cluster a_{k-L-K}_{₁}^{k+K}^{₂}, and σ²(a_{k-L-K}_{₁}^{k+K}^{₂}) is the variance of the whitened noise. Thus a scheme to estimate and track the prediction vector ρ(a_{k-L-K}_{₁}^{k+K}^{₂}) can be simply based on minimizing E[(wₖ^{T}Nₖ)²]. The overall estimation scheme is shown in FIG. 5. At every clock cycle, one prediction vector ρ(a_{k-L-K}_{₁}^{k+K}^{₂}) and one variance σ²(a_{k-L-K}_{₁}^{k+K}^{₂}) are adapted. The adaptation of the prediction vector is based on the least mean square (LMS) technique and seeks to minimize (wₖ^{T}Nₖ)². The adaptation of ρ(a_{k-L-K}_{₁}^{k+K}^{₂}) and estimation of σ²(a_{k-L-K}_{₁}^{k+K}^{₂}) are given by:

ρ(a)^{new}=ρ(a)^{old}+μ_{ρ}(w^{old}(a)^{T}Nₖ)nₖ

σ²(a)^{new}=(1−μ_{σ}_{²})σ²(a)^{old}+μ_{σ}_{²}(w^{old}(a)^{T}Nₖ)nₖ, (16)

where μ_{ρ} and μ_{σ}_{²} denote the adaptation constants for the adaptation of ρ(a_{k-L-K}_{₁}^{k+K}^{₂}) and estimation of σ² (a_{k-L-K}_{¹}^{k+K}^{₂}), nₖ=[nₖ₋₁, . . . , n_{k-L}]^{T}, a=a_{k-L-K}_{₁}^{k+K}^{₂}.

In practice, nₖ is not available to the receiver and the adaptation of the prediction parameters has to be based on the error signal eₖ instead. The estimated parameter σ² (a_{k-L-K}_{₁}^{k+K}^{₂}) can be stored in the memory 430 of FIG. 4.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A digital synchronous communication system including a digital synchronous communication channel (110) for time-synchronous transfer of a sequence of data symbols a₁, . . . , a_{N} and a receiver (130); the receiver including:
a sampling unit (132) for time-sequential sampling an output of the channel under control of a sampling clock signal that is synchronous with transmittal of the data symbols on the channel; each sample of the sequence of samples including a representation of a data symbol and noise; and
a data-aided timing error detector (133) for providing a correction signal for correcting the sampling clock signal; the timing error detector being coupled to the sampling unit for receiving a representation of the time sequence of samples and including:
a data-dependent noise predictor (310) for generating a predicted noise sequence \hat{n}₁, . . . , \hat{n}_{N} where each predicted noise value \hat{n}ₖ for the k-th sample of the sequence depends on a cluster of a plurality of sampled data symbols; and
a noise whitening unit (320) for whitening of noise in the sample sequence by removing the predicted noise value \hat{n}ₖ;
the timing error detector being arranged to provide the correction signal in dependence on the whitened sample sequence.

2. A system as claimed in claim 1, wherein the noise-predictor is arranged to use a data-dependent finite-order Markov process for modeling the noise.

3. A system as claimed in claim 1, wherein the timing error detector is arranged to perform a maximum likelihood timing error detection.

4. A system as claimed in claim 2, wherein the timing error detector is arranged to adaptively estimate parameters of the noise model on a sample-by-sample basis.

5. A system as claimed in claim 1, wherein the timing error detector further includes means for determining a reliability measure of a cluster of samples and further being arranged to provide the correction signal by weighing a gain in extraction of timing information for a cluster of samples by the determined reliability measure by assigning a higher gain weight to more reliable clusters.

6. A system as claimed in claim 5, wherein the reliability measure is a noise variance of the whitened noise sequence.

7. A system as claimed in claim 6, wherein the gain weight is inversely proportional to the noise variance.

8. A system as claimed in claim 1 further including a storage device acting as a source of the communication channel.

9. A receiver for use in the system of claim 1; the receiver including:
a sampling unit (132) for time-sequential sampling an output of a digital synchronous communication channel (110) used for time-synchronous transfer of a sequence of data symbols a₁, . . . , a_{N}; the sampling being under control of a sampling clock signal that is synchronous with transmittal of the data symbols on the channel; each sample of the sequence of samples including a representation of a data symbol and noise; and
a data-aided timing error detector (133) for providing a correction signal for correcting the sampling clock signal; the timing error detector being coupled to the sampling unit for receiving a representation of the time sequence of samples and including:
a data-dependent noise predictor (310) for generating a predicted noise sequence \hat{n}₁, . . . , \hat{n}_{N} where each predicted noise value \hat{n}ₖ for the k-th sample of the sequence depends on a cluster of a plurality of sampled data symbols; and
a noise whitening unit (320) for whitening of noise in the sample sequence by removing the predicted noise value \hat{n}ₖ;
the timing error detector being arranged to provide the correction signal in dependence on the whitened sample sequence.

10. A method of providing a correction signal for correcting a sampling clock signal for time-sequential sampling an output of a digital synchronous communication channel for time-synchronous transfer of a sequence of data symbols a₁, . . . , a_{N} under control of a sampling clock signal that is synchronous with transmittal of the data symbols on the channel; each sample of the sequence of samples including a representation of a data symbol and noise; the method including:
receiving a representation of the time sequence of samples;
generating a predicted noise sequence \hat{n}₁, . . . , \hat{n}_{N} where each predicted noise value \hat{n}ₖ for the k-th sample of the sequence depends on a cluster of a plurality of sampled data symbols;
whitening noise in the sample sequence by removing the predicted noise value \hat{n}ₖ; and
providing the correction signal in dependence on the whitened sample sequence.

11. A computer program product for causing a processor to execute the method of claim 10.
